(19) United States
(12) Patent Application Publication
(10) Pub. No.: US 2020/0210499 A1
(43) Pub. Date: Jul. 2, 2020

(54) AUTOMATICALLY LINKING PAGES IN A WEBSITE

(71) Applicant: Microsoft Technology Licensing, LLC, Redmond, WA (US)

(72) Inventors: Shen Huang, San Jose, CA (US); Wanyan Xie, San Jose, CA (US); Yanjin Kuang, Foster City, CA (US); Eric Huang, San Jose, CA (US); Anna Matalon, San Francisco, CA (US)

(21) Appl. No.: 16/235,107

(22) Filed: Dec. 28, 2018

(51) Int. Cl. G06F 16/958; G06F 16/2457; G06Q 10/10; G06N 20/00

(52) U.S. Cl. CPC G06F 16/958; G06N 20/00; G06Q 10/1053; G06F 16/24578

(57) ABSTRACT

A method and system for optimizing links to web pages for electronic content are provided. Multiple candidate entities that are associated with a particular entity are identified. Identifying the candidate entities includes at least the steps of identifying a set of entities that is associated with a particular organization with which the particular entity is associated, ranking the set of entities based on one or more criteria, and selecting a subset of entities from the set of entities. Based on the selection, a plurality of links is included in a particular web page for the particular entity. Each link is configured to link to a web page of a different entity of the subset of entities.

### TECHNICAL FIELD

The present disclosure relates to electronic content delivery across one or more computer networks and, more particularly to, professional similarity optimization of links to electronic content.

### BACKGROUND

The internet allows end users operating computing devices to be presented with a web page including electronic content that is relevant to search content. Often times, the end users may not only view a web page that includes the electronic content (e.g., professional profile of a particular member) that is presented in response to a search query (e.g., name of the particular member), but also additional electronic content (e.g., other members' professional profiles) that is accessible through links on the web page, because the end users may find that the additional electronic content accessible by the links may also be relevant to the search result (e.g., finding a member that is professionally similar to the particular member).

One approach to identifying additional electronic content is to rely on keyword-based content similarity. This is referred to as a content-based approach. However, this approach has not consistently resulted in generating high-quality links for certain web pages. In another approach to identifying additional electronic content is to analyze online behavior to determine what two content items users have viewed together in a short period of time. This is referred to as a user behavior approach, which includes collaborative filtering. However, sometimes enough data of user behavior cannot be collected, particularly for member profiles that are relatively new and/or that are not associated with many online connections.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1A is a block diagram that depicts an example system for determining content to which one or more web pages of a website should link, in an embodiment;

FIG. 1B is a block diagram that depicts a process for selecting one or more content items from among candidate content items;

FIG. 1C is a block diagram that depicts, an example link structure from a web page, in an embodiment;

FIG. 2 is an example user interface for presenting electronic content with links to other pages with additional electronic content, in an embodiment;

FIG. 3 is a flow diagram that depicts an example process for optimizing links to electronic content, in an embodiment;

FIG. 4 is a block diagram that depicts components for optimizing links to electronic content, in an embodiment; and

FIG. 5 is a block diagram that illustrates a computer system upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention. Embodiments are disclosed in sections according to the following outline:

1. GENERAL OVERVIEW
1.1. TECHNICAL IMPROVEMENTS

2. SYSTEM OVERVIEW

3. EXAMPLE COMPUTER-GENERATED GRAPHICAL USER INTERFACE

4. EXAMPLE PROCESS

5. FUNCTIONAL DESCRIPTION AND COMPONENTS
5.1. ENTITIES POOL
   5.1.1. COMMON ORGANIZATION
   5.1.2. TIME OVERLAP
5.2. SELECTING TOP N ENTITIES
   5.2.1. FAMILIARITY ATTRIBUTES
   5.2.2. PROFESSIONAL SIMILARITY
   5.2.3. PROFESSIONAL SENIORITY
   5.2.4. LINEAR COMBINATION
5.3. OPTIMIZATION
   5.3.1. BEHAVIOR FEEDBACK DATA
   5.3.2. LABELED DATA
   5.3.3. REGRESSION MODEL

6. HARDWARE OVERVIEW

### 1. General Overview

A method and system for optimizing links to web pages for electronic content are provided. Multiple candidate entities that are associated with a particular entity are identified. Identifying the candidate entities includes at least the steps of identifying a set of entities that is associated with a particular organization with which the particular entity is associated, ranking the set of entities based on one or more criteria, and selecting a subset of entities from the set of entities. Based on the selection, a plurality of links is included in a particular web page for the particular entity. Each link is configured to link to a web page of a different entity of the subset of entities.

1.1 Technical Improvements

Embodiments described herein improve the utility of electronic content delivery methods for the end users by providing related and relevant content in response to a search query. Past approaches do not consider online network information, such as common connections and professional seniority information, when determining links to additional electronic content. Embodiments improve user experience and interaction with a computing device and maximize organic traffic by presenting content that ensures relevance and similarity. Embodiments leverage characteristics of online networks to build links directed to similar entities, improve each web page's page rank relative to other web pages, and avoid cold start issues of the user behavior approach.

### 2. System Overview

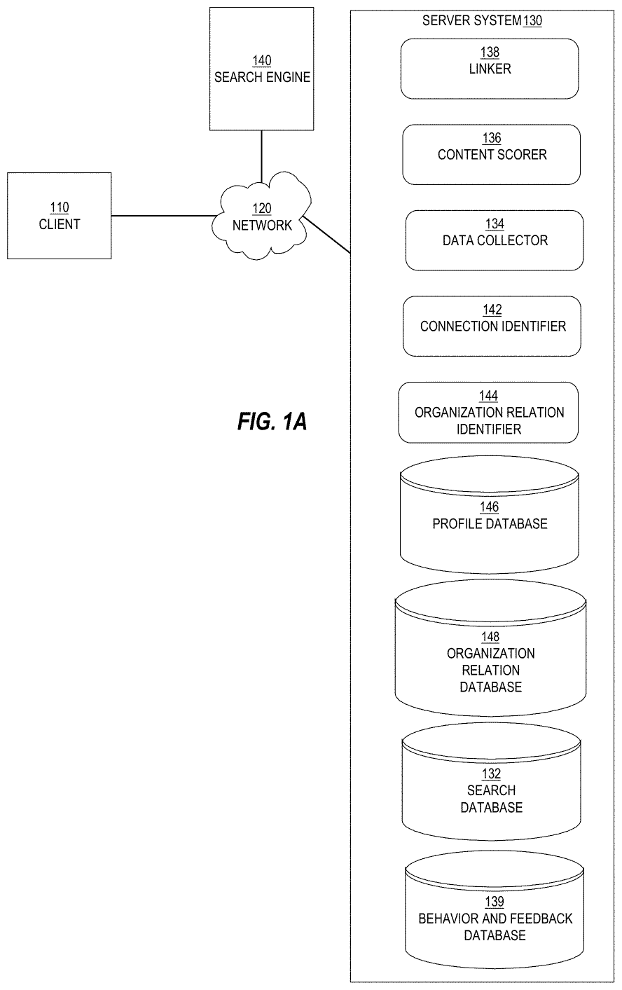

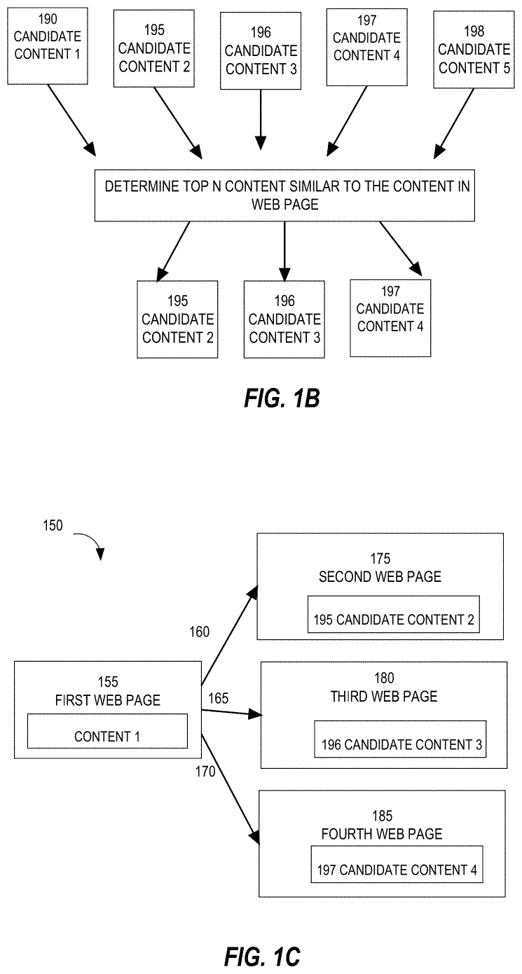

FIG. 1A is a block diagram that depicts an example system 100 for determining content to which one or more web pages of a website should link, in an embodiment. System 100 includes a client device 110, a network 120, a server system 130, and a search engine 140.

Client 110 is an application or computing device that is configured to communicate with server system 130 over network 120. Although only a single client 110 is depicted, system 100 may include multiple clients that interact with server system 130 over network 120. Examples of computing devices include a laptop computer, a tablet computer, a smartphone, a desktop computer, and a Personal Digital Assistant (PDA). An example of an application includes a dedicated application that is installed and executed on a local computing device and that is configured to communicate with server 130 over network 120. Another example of an application is a web application that is downloaded from server system 130 and that executes within a web browser executing on a computing device. Client 110 may be implemented in hardware, software, or a combination of hardware and software.

Network 120 may be implemented on any medium or mechanism that provides for the exchange of data between client 110 and server system 130. Examples of network 120 include, without limitation, a network such as a Local Area Network (LAN), Wide Area Network (WAN), Ethernet or the Internet, or one or more terrestrial, satellite or wireless links.

Server system 130 may provide a web service, such as a social networking service. Examples of social networking service include Facebook, LinkedIn, and Google+. Although depicted as a single element, server system 130 may comprise multiple computing elements and devices, connected in a local network or distributed regionally or globally across many networks, such as the Internet.

Server system 130 includes a search database 132, a data collector 134, a content scorer 136, and a linker 138, profile database 146, connection identifier 142, organization relation identifier 144, organization relation database 148, and behavior and feedback database 139. Server system 130 may be implemented on a single computing device or on multiple computing devices. Each of data collector 134, content scorer 136, linker 138, profile database 146, connection identifier 142, organization relation identifier 144, organization relation database 148, and behavior and feedback database 139 may be implemented in software, hardware, or any combination of software and hardware. Although depicted separately, these components may be implemented as one component.

Search Database

Search database 132 stores data that is used to generate web pages of a particular website (that may be hosted by server system 130), search results, and/or data about accesses to, and user interactions with, the content. A web page is a combination of multiple content items that contains zero or more links that link to one or more other web pages. A web page may be linked to by one or more other web pages. Example content includes text, audio, video, and an executable.

Profile Database

Profile database 146 comprises persistent storage and/or volatile storage. The storage may comprise a single storage device or multiple storage devices. The storage may be part of server system 130 (as implied in FIG. 1A) or may be accessed by server system 130 over a local network, a wide area network, or the Internet.

In an embodiment, profile database 146 comprises multiple user profiles, each provided by a different user. In this embodiment, server system 130 maintains accounts for multiple users. A user's profile may include a first name, last name, an email address, residence information, a mailing address, a phone number, one or more educational institutions attended, one or more current and/or previous employers, one or more current and/or previous job titles, a list of skills, a list of endorsements, and/or names or identities of friends, contacts, or connections of the user. Online user actions may be stored separately from, but is otherwise associated with (e.g., through a unique user identifier), profile database 146. Some data within a user's profile (e.g., work history) may be provided by the user while other data within the user's profile (e.g., skills and endorsement) may be provided by a third party, such as a “friend” or connection of the user or a colleague of the user.

Behavior and Feedback Database

As users interact with electronic content on the user interfaces of the server system 130, information relating to the user's behavior or activity are stored in a behavior and feedback database 139. Examples of the user behavior or activity may include submitting search queries, clicking links on the web pages, staying or leaving the web pages, each of which can be represented as metrics associated with CTR (Click-Through Rate), selection rate, bounce rate, or pair-wise bounce rate.

Data Collector

Data collector 134 collects data about multiple content items. In one embodiment, data collector 134 can collect data from the databases in server system 130. In order to collect data, data collector 134 may examine multiple sources of data, such as searching search logs indicating user behavior relative to content, submitting search queries to search engine 140 to perform searches and analyzing the results of those searches and text of certain portions of content. Some of the information collected and included in the search engine results are people names, company names, job titles, job skills, salary, location, or learning-related keywords.

Content Scorer

For each content item, content scorer 136 generates a score for the content item based on the data collected by data collector 134 for that content item. As described in more detail herein, content scorer 136 implements an optimization algorithm to determine to which content item a web page should link. The optimization algorithm uses weights or coefficients for attributes that are considered in generating a score to rank the content items and the web pages.

As described in more detail herein, a score for a content item may take into account one or more attributes pertaining to the content item itself and, optionally, one or more attributes pertaining to a combination of the content item and a web page (i.e., that links to the content). Thus, content scorer 136 generates multiple scores for a content item, one score for each candidate web page from which a link to the content item may be included.

Linker

For a particular web page, linker 138 uses the scores relative to multiple candidate content items to select a subset of the candidate content items to which the particular web page should include a link (e.g., a URL). For example, linker 138 may rank the multiple candidate content items based on the associated scores (e.g., similarity) and select the top N candidate content items. Linker 138 then includes a link in the particular web page for each of the N candidate content items.

As a specific example, one content item may be about a particular professional profile that specifies positions held, particular skills, education level, or background information. Another content item that is determined to have a higher score than a particular threshold score may be one that includes another professional profile that is professionally relevant and similar to the particular professional profile (e.g., same company or same education). In another example, scores for a content item may indicate professional seniority, professional similarity, or familiarity attributes. Other content items that are determined to have higher scores than a particular threshold score may be one that shares professional seniority, professional similarity, or familiarity attributes.

Example Link Structure

FIG. 1B is a block diagram that depicts selecting a subset of candidate content items, in an embodiment. FIG. 1C is a block diagram that depicts, an example link structure 150 from first web page 155, in an embodiment. Data collector 134 collects data about each of candidate content items 190-198. Content scorer 136 generates a score for each of the content items. Linker 138 ranks the content items by the score, selects content items 195-197 that will be presented on the first web page 155, and includes links 160-170 to those content items 195-197, respectively.

For example, as shown in FIG. 1C, first web page 155 includes links 160-170 to, respectively, web pages 175-185 with the selected content items 195-197. Each web page includes respective content items 195-197, each content item included in the respective web page is selected based on the ranking criteria. In some embodiments, the web pages 175-185 may include electronic content associated with professional profiles of different users.

Also, in this example, the slots in web page 155 that include links to content items are ordered. The content item that has the highest score is placed in the “first” slot of the first web page 155. Similarly, the content item that has the second highest score is placed in the “second” slot of the first web page 155.

Scoring Content

Multiple attributes may be considered when scoring content items. Example attributes of scoring content include:
a. content relevance: a similarity score between the content of a first web page and particular content of other pages.
b. selection rate (e.g., click-through rate or CTR): a number of times that users have landed on the source page and moved to the particular content item divided by a number of times that users have landed on the source page;
c. bounce rate: a number of times users return to a source page (i.e., that links/linked to the particular content item) when the users selected the link to the particular content item vs. a number of times users selected a link to the particular content item
d. average staying time: an average time (e.g., in seconds) a user “stays” with the particular content item (or “stays on” the web page, if the particular content item is a web page) before changing the view (e.g., by clicking on a link in the particular content item, returning to the source page, closing an application that presents (e.g., displays) the particular content item, typing in a new URL in a web browser, or launching a different application)
e. average interactions: an average number of interactions that users have with the particular content item, such as an average number of clicks on items within the particular content item, an average number of scrolling actions, an average number of selections of a user interface of the particular content item, etc.
f. pair-wise bounce rate: a number of times that users landed on the source page, then moved to the particular content item and then went back to the source page divided by a number of times that users landed on the source page and then moved to the particular content item.

### 3. Example Computer-Generated Graphical User Interface

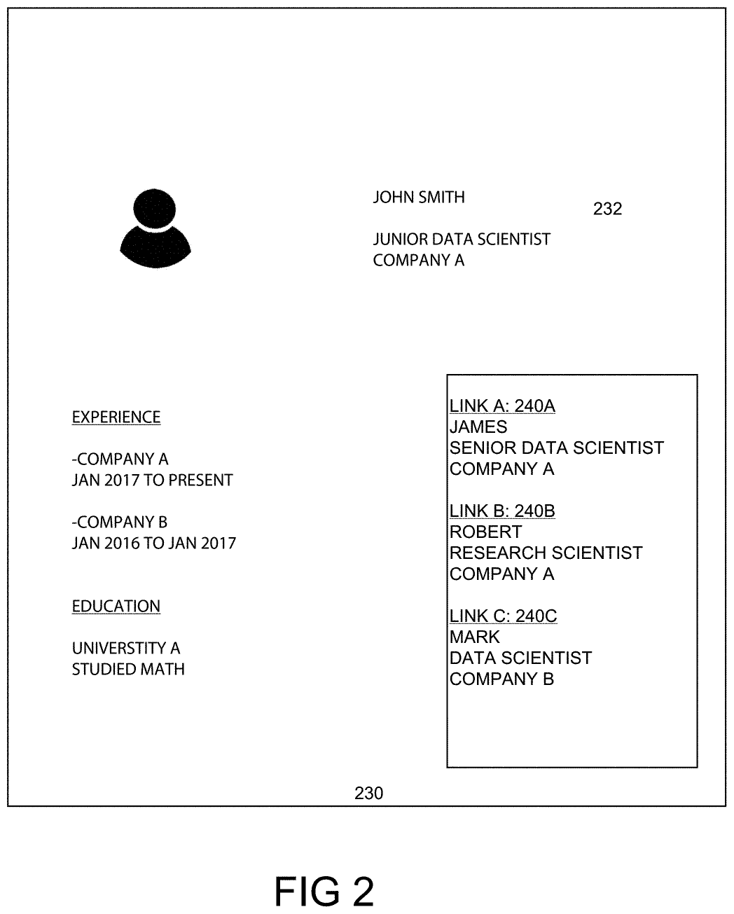

FIG. 2 is an example computer-generated graphical user interface that displays electronic content and links to other pages with additional electronic content.

The electronic content includes any of text, image, video, or link that is presented on a web page or an application. Non-limiting examples of electronic content include user's professional profile, job postings, company profiles and learning content. To describe embodiments, electronic content related to a professional profile is used herein.

A professional profile includes a sequence of positions held by the corresponding entity (e.g., a registered member). A professional profile includes a job description for each listed position, such as job title, job function, job location, employer name, industry background. A professional profile may also include educational history (e.g., degree, major, field of study, coursework) and entity connection data (e.g., first-degree connections with other entities). One or more professional attributes related to a professional profile such as current and past job titles, current and past job locations, current and past job descriptions, current and past employer names, educational background, industry experience, skills and certificate information, may be used herein to describe the embodiments.

In some embodiments, the screen display can be illustrated as a first web page 230 including a professional profile of first entity (John Smith) 232 and links 240A, 240B, 240C to other pages. To explain embodiments more clearly, an entity herein refers to an individual member/user who is associated with a respective professional profile. A particular entity can be referred to as a “particular member,” the first web page 230 may be referred to as a “source page” or “source web page,” other members who are linked to through links are referred to as “similar members.”

Upon clicking one of the links 240A-240C, a new web page (e.g., second web page) that includes a professional profile of a second entity who is professionally similar to the first entity presented on first web page 230 may be displayed. The second entity can be professionally similar to the first entity if the second entity's career trajectory is similar to the first entity's career trajectory. For example, if the two entities held a common or similar position, worked on a common or similar project, worked at the common or similar company, or went to a common or similar school, then these two entities are determined to be professionally similar with each other than other entities who do not share similar professional attributes.

In some embodiments, first web page 230 is presented as a search result in response to a search query (e.g., John Smith). Upon receiving the search query, professional profile 232 can be presented in a main panel of the computer-generated graphical user interface and links 240A-240C can be presented in a particular panel that can be visually distinguished from the main panel.

The links 240A-240C may be relevant to the professional profile 232 in its professional attributes such that the job characteristics, job requirements, job skills, salary requirements, or job description may be similar. As shown in FIG. 2A, link 240A illustrates a professionally similar entity who shares same/similar attributes, including a similar job title (i.e., Senior Data Scientist) and common company (i.e., Company A). Link 240B illustrates another professionally similar entity who shares same/similar attributes, including a similar job title (i.e., Research Scientist) and common company (i.e., Company A). Link 240C illustrates another professionally similar entity who shares same/similar attributes, including a similar job title (i.e., Data Scientist) and common previous company (i.e., Company B). Other links may illustrate related professional links that share similar attribute values in attributes other than job title and employer.

In some embodiments, to increase the user traffic and page ranking, link 240A may be ranked higher than (e.g., presented above) links 240B-240C if it is determined that the professional seniority value is higher than the professional seniority values of the other entities. Also, any entity that is more relevant and similar to the particular user presented on the web page 230 is likely to be ranked higher and the link may be placed in an earlier slot in the web page 230. In a specific example, the entity (James) associated with link A has a higher professional seniority value because he is a “senior data scientist.” Moreover, James works at the same company (company A) with the particular user (John); thus, the link for James is placed in the first slot. Next, Robert who works at the same company as John (company A) may be placed in the second slot on the web page 230. Mark, on the other hand, has the same title as John (data scientist), but currently works at a previous company (company B) of the particular user; thus, a link to Mark's profile is placed in the third slot on the web page 230.

### 4. Example Process

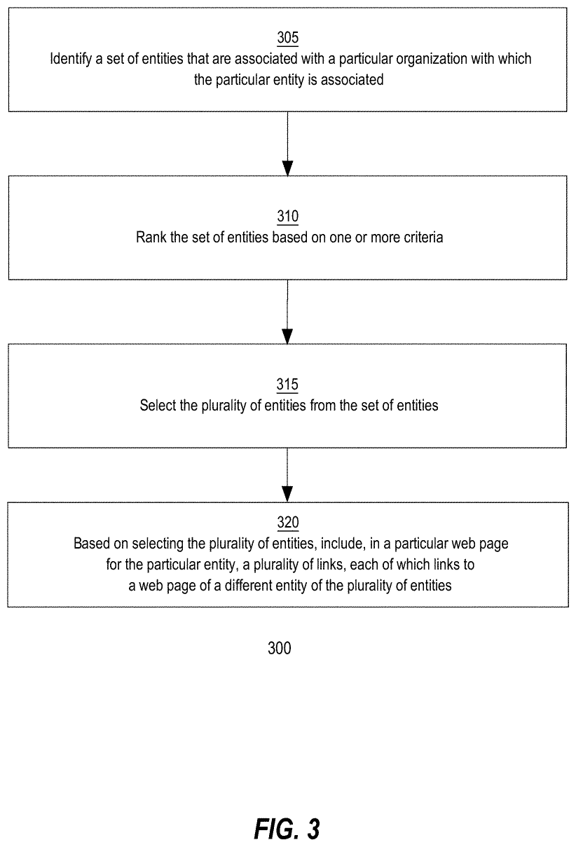

FIG. 3 is a flow diagram that depicts a process 300 for optimizing links to electronic content, in an embodiment. In some embodiments, the process 300 may be performed in a backend server as a batch process.

At step 305, a set of entities that is associated with a particular organization with which a particular entity is associated is identified. If the particular organization is listed as a previous or current employer in the profile of an entity, then the particular organization is associated with the entity. The entity may specify previous or current employers in the professional profile that is stored in the profile database. In some embodiments, step 305 may involve determining a set of entities whose period of employment at the particular organization (or similar organization) overlaps with the particular entity's period of employment at the particular organization.

At step 310, the set of entities is ranked based on one or more ranking criteria. The one or more criteria include familiarity attribute criteria (e.g., common connection, common employer, time of overlap, or common school), professional similarity attribute criteria (e.g., job title, project description, or education description), or professional seniority attribute criteria. The values for one or more criteria can be extracted from the user profile data.

At step 315, a plurality of entities from the set of entities is selected. The selection may be based on a linear combination algorithm using the corresponding weights for each criterion. In one embodiment, each criterion may be assigned the same or random weights.

At step 320, based on the selection, each link associated with a different entity of the selected entities is included in a web page (e.g., source page) for the particular entity. Each link links to another web page showing a professional profile of the different entity.

In some embodiments, feedback data from the user may be collected. Feedback data can be determined by the user interaction with the electronic content. Non-limiting example user interactions include click-through rate (CTR), bounce rate, average staying time, average interactions, pair-wise bounce rate or user traffic. For each example interaction, the metric value is tracked to calculate weight value for each feature.

The feedback data is used to generate labeled data. A prediction model is trained to predict the performance of providing relevant links to electronic content. The prediction model is trained to predict whether a candidate link (associated with a candidate member) will be selected. In one embodiment, one or more machine learning techniques are applied to the labeled data to determine updated coefficients or weights associated with each feature of the prediction model. The updated prediction model is eventually used to select links for a set of web pages, some of which may have been the subject of previous link selections using a previous version of the prediction model.

### 5. Functional Description and Components

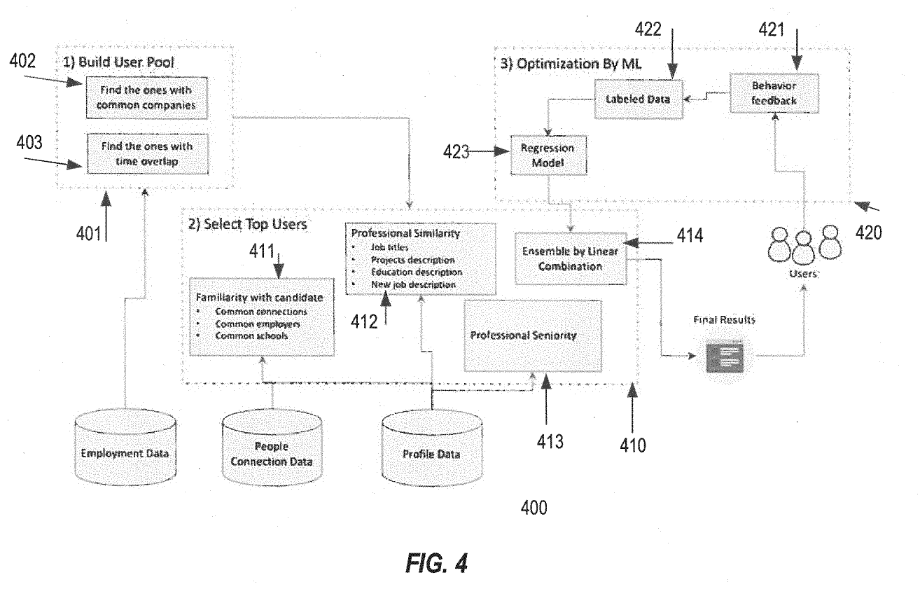

FIG. 4 is a block diagram that depicts components for optimizing links to electronic content. At block 401, the process 400 identifies a set of entities (e.g., members or candidates) who have previously worked or are currently working at the particular organization (e.g., company A) with which the particular entity (e.g., John Smith) is associated or that is listed in a profile of the particular entity.

5.1. Entity Pool

At block 402, a set of entities that is associated with a particular organization with which a particular entity is identified. If the particular organization is listed as a previous or current employer in the profile of the particular entity, then the particular organization is associated with the particular entity. An organization herein refers to any organization that engages in work or activities such as a business unit, company, corporation, school, partnership, governmental entity, or non-profit organization; however, the organization list is not limited to the foregoing examples. In one embodiment, the entity refers to any user that is a member of an organization.

Profile data can be received from the profile database 146. Employment data such as employer information or period of employment can be extracted from the profile data. Based on the employment data, an entity and a particular organization associated with the entity is determined. For example, member A (e.g., employee) may be identified as an individual entity and a company at which the member A works (e.g., employer) may be identified as a particular organization.

In one example, the identified set of members can be first-degree connections of the particular member (directly connected). In another example, the identified set of members can be second-degree connections of the particular member who are connected to the particular member's first-degree connections. In one example, the identified set of members can be the third-degree connections of the particular member who are connected to the particular member's second-degree connections.

5.1.1. Common Organization

An organization may be any type of organization, such a company (examples of which include a proprietorship, a partnership, and a corporation), a government agency, an academic institution, a non-profit organization, and a charitable organization.

In one embodiment, the common organization can be an identical (i.e., same) organization. Alternatively, the common organization can be a similar organization (but not identical). For example, process 400 determines similarity scores indicating similarity between the particular organization and multiple organizations. With the similarity scores, the process determines how similar the organizations are compared to the particular organization. The common organization may be one that has a similarity score that is higher than a particular threshold value. If it is determined that the similarity scores for organizations (e.g., LCD chip manufacturers) are higher than the threshold score, then the organizations are determined to be similar to the particular organization (e.g., monitor chip manufacturer) in its character. These organizations may be identified as a common organization even though they are not the identical organization.

People Connections

With respect to two organizations, a “people connection” is a connection between employees of the two organizations. Connection identifier 142 determines an employment relationship with an organization by analyzing the name of an employer in a user's profile. Connection identifier 142 determines a friend relationship between two users by analyzing a friend or connection list of one of the users and determining that the other user is listed in the friend/connection list (which may comprise a list of user or account identifiers). The more people connections there are between two organizations, the more likely that both organizations are related.

People tend to form professional connections with (a) colleagues in the same or similar industry and (b) business relations. For example, people may connect with alumni and colleagues/business partners/attendees of the same conference. People are also likely to work for similar companies. Once people connections are aggregated with respect to two organizations, an organization relation may be clearly revealed.

In an embodiment, one or more criteria is used to determine whether two organizations are related. One of the criteria includes a frequency or number of people connections. If the number of people connections between two organizations is above a particular threshold, then the two organizations are considered to be related. In a related embodiment, different industries have different thresholds.

In a related embodiment, size of an organization is a factor in determining whether two organizations are related. If not, then even a relatively few numbers of people connections between two relatively large organizations (e.g., 10,000+ employees) might cause ORI 144 to identify those two organizations as related. By taking into account the size of one or both of the organizations, a more accurate determination may be made. For example, if the ratio of (1) the number of people connections between two organizations to (2) the number of employees of one of the organizations is greater than a particular threshold (e.g., 1/20 or 5%), then the two organizations are considered related. The number for (2) may be the larger organization or the smaller organization. The number for (2) may be determined by analyzing user profiles that list one of two organizations in the respective user profiles as an employer.

Organization size may be determined in one or more ways. For example, the size of an organization may be determined by totaling the number of users that list that organization as an employer in their respective user profiles. As another example, size of an organization may be determined based on a size listed on the organization's profile page. As another example, size of an organization may be determined based on extracting size data from a third-party source, such as an SEC listing, a Wikipedia page, or an article found on a third-party website.

In an embodiment, an organization relation may be symmetric or asymmetric. For example, a first organization may be designated as related to a second organization but not vice versa. For example, ORI 144 determines that the first organization has 20 employees, the second organization has 10,000 employees, and there are 10 people connections between the two organizations (based on analysis of connection identifier 142). Based on the ratio of 10/20, ORI 144 determines that the first organization is related to the second organization. However, based on the ratio of 10/10,000, ORI 144 determines that the second organization is not related to the first organization. This may be the case if, for example, both organizations are in the same industry, the first organization is spin-off of the second organization but offers only a single targeted service while the second organization offers many services.

In some cases, many (e.g., thousands or tens of thousands) users might list a particular organization as their employer. Thus, determining people connections between that particular organization and each other possible organization may take a significant amount of time and require significant computing resources. Therefore, in an embodiment, a sampling of users (e.g., a maximum of five hundred) that list an organization in their respective profiles is performed. Then, the number of people connections between two organizations may be determined from that sampling. For example, if there are 20 people connections determined from sampling and one of the organizations was sampled by considering only five hundred connections, and it is known that the organization has five thousand employees, then the number of estimated people connections may be determined as follows: 20*(5,000/500)=200. This approach reduces the number of computing resources utilized and time to compute an organization relation.

Weighted People Connections

In an embodiment, different people connections have different weights. Thus, some people connections are weighted higher than other people connections. For example, common values for certain user profile attributes are weighted higher than others. Examples of such profile attributes include industry, job title, job function, academic institution, and geographic location. Some of these attributes may be weighted higher than others. For example, the fact that two connected users list the same job title in their respective profiles is weighted higher than if the two connected users list the same geographic location (or the same academic institution) in their respective profiles. As another example, if two users of a people connection share the same last name (particularly uncommon names), then such a people connection is weighted lower because it may be presumed that the people connection is primarily a familial connection rather than a business connection.

In an embodiment, online behavior of two users of a people connection may cause a weight for that connection to increase. Examples of online behavior is a number of online messages sent between the two users (e.g., through a messaging service provided by server system 130), a number of views by one user of the other user's profile, a recency of such online actions (e.g., more recent actions are weighted higher than older actions), one user providing an endorsement of the other user (to be placed in the other user's public profile), and one user interacting with online connect associated with the other user. Examples of “online interactions” include commenting on, “liking,” or “sharing” another user's online article/post. Some online interactions by one user relative to another user may be weighted higher than other online interactions.

Employment Connections

With respect to two organizations, an “employment connection” is a connection or association between two organizations based on a single user's employment-related actions relative to those two organizations. An employment-related action includes working for an organization (which can be determined by analyzing the name of an employer in the user's profile), applying for a job provided by the organization, and viewing one or more job postings regarding jobs provided by the organization. For example, if a user lists a first organization as an employer in his/her user profile and then lists a second organization as an employer in his/her user profile, then an employment connection between the first organization and the second organization is identified. As another example, if a user lists a first organization as an employer in his/her user profile and then applies for a job provided by a second organization, then an employment connection between the first organization and the second organization is identified. The more employment connections there are between two organizations, the more likely that both organizations are related.

Connection identifier 142 determines whether an employment connection between two organizations exists. Thus, connection identifier 142 determines the two different types of connections. Alternatively, server system 130 includes two different connection identifiers: (1) a people connection identifier for identifying people connections and (2) an employment connection identifier for identifying employment connections.

In an embodiment, there may be an inverse correlation between the length of time spent employed by one organization and the strength or weight of an associated employment connection. For example, an employment connection between a first organization and second organization where a user that lists (in his/her profile) the first organization for a relatively long period of time (e.g., greater than seven years) may have a lower weight than an employment connection between the two organizations where a user lists the first organization for a lesser period of time (e.g., less than five years).

Additionally, employment connections that occurred relatively recently (e.g., within the last year) may have a higher weight than employment connections that occurred long ago. Thus, a decay-with-time rate may be applied to each employment connection to determine a weight of that employment. The decay-with-time rate may be reflected in a linear function, a logarithm function, an exponential function, or any other type of function.

In an embodiment, an employment connection may be symmetric or asymmetric. For example, a first organization may be designated as related to a second organization but not vice versa. This may be the case if, for example, many users have moved from one organization to another, but not vice versa. For example, ORI 144 determines that two hundred former employees of a first organization changed employers and are now employed by a second organization, but only five former employees of the second organization changed employers and are now employed by the first organization. In this example, the employment (or talent) flow is from the first organization to the second organization. Thus, ORI 144 may determine that the second organization is related to the first organization but determines that the first organization is not related to the second organization.

In an embodiment, similar to people connections, employment connections between two organizations may be normalized based on the size of one or both of the organizations. For example, ORI 144 determines that a first organization has 20 employees, a second organization has 10,000 employees, and there are 10 employment connections between the two organizations. Based on the ratio of 10/20, ORI 144 determines that the first organization is related to the second organization. However, based on the ratio of 10/10,000, ORI 144 determines that the second organization is not related to the first organization.

ORI 144 stores results in organization relation database 148 as records, each record containing two organization identifiers (e.g., a name, or randomly generated alphanumeric value). Organization relation database 148 may contain only affirmative results (i.e., that two organizations are related) or both affirmative results and negative results (i.e., that two organizations are not related).

Another component of server system 130 (not shown) requests information from organization relation database 148. A request may include a single organization identifier/name, two organization identifiers/names, or a list of organization identifiers/names. A request that includes a single organization identifier may implicitly ask for all organization identifiers/names that are considered related (e.g., by ORI 144) to the organization identified by the organization identifier. A request that includes two organization identifiers may implicitly ask for whether the two organizations identified by the organization identifier are related. A request that includes a list of organization identifiers may implicitly ask for, for each organization identified by an organization identifier in the list, all organization identifiers/names that are considered related to that organization. The records in organization relation database 148 may be ordered based on an organization identifier, organization name, or any other ordering criteria. The records in organization relation database 148 pairs may be indexed such that a table scan of each record is not necessary to (a) determine whether two organizations are related or (b) identify all relations pertaining to a particular organization.

5.1.2. Time Overlap

At block 403, from the identified members, the process 400 identifies a set of members whose period of employment at the particular organization (or similar organization) overlaps with the particular user's period of employment at the particular organization. In other words, the process 400 receives a start time and an end date of the employment period at the particular organization for the particular member and the identified candidate members from the profile database 146, and determines whether the particular user's period of employment at the particular organization overlaps with any of the identified members' employment period at the particular organization.

For example, if member A worked at company X from January 2017 to January 2019, and member B worked at company X from January 2016 to March 2018, then member B is included in the set of candidate members because the member B's period of employment at company X at least partially overlaps with the member A's period of employment at company X (January 2017-March 2018).

In some embodiments, the process 400 may determine that a candidate member whose employment period does not overlap with the particular member's employment period may still be qualified as a candidate member, if the employment period of candidate member is proximate (i.e., very close without overlap) to the employment period of a particular member. For example, if member A worked at company X from January 2016 to January 2017, and member B worked at company X from February 2017 to March 2018, then member B's period of employment at company X can be determined to be proximate enough to be determined to be overlapped with the member A's period of employment at company X (one month difference); thus, member B is included in the set of candidate members.

Based on the determination performed at block 401, a user pool (candidate pool) associated with the common organization with the overlapped period of employment is created. The user pool may further be ranked based on one or more ranking criteria, such as amount of time of overlap. Thus, the longer that a particular member and a candidate member overlapped at a particular company, the higher the rank of the candidate member relative to other candidate members.

5.2. Selecting Top N Entities

At block 410, the set of entities (e.g., members) are ranked based on one or more ranking criteria. The one or more criteria include familiarity attribute criteria (e.g., common connection, common employer, time of overlap, or common school), professional similarity attribute criteria (e.g., job title, project description, or education description), or professional seniority attribute criteria. The listed criteria are not an exclusive list and may include other criteria. The values for one or more criteria can be extracted from the user profile data.

5.2.1. Familiarity Attributes

In the depicted embodiment, block 410 includes multiple sub-blocks, such as blocks 411-414. At block 411, familiarity attributes are determined for each identified set of members. The familiarity attributes represent a level of close acquaintance between the particular member and candidate members. The familiarity attributes can be determined based on the members' connection information, employer information, or school information. In other words, the more common attributes the candidate members have with the particular member, those candidate members are likely to be ranked higher than other candidate members who have fewer common attributes.

For example, if a candidate member went to the same school with a particular member, then that candidate member is ranked higher than another candidate member who did not go to the same school (as reflected in their respective online profiles). If a candidate member worked at the same company with the particular member previously, then that candidate member is ranked higher than another member who did not work at the same company. If a candidate member has five common connections with the particular member, then that candidate member is more likely to be ranked higher than another candidate member who has three common connections with the particular member.

5.2.2. Professional Similarity

At block 412, the professional similarity is determined for each identified candidate in a set of candidate members. The professional similarity represents a level of professional profile similarity between the particular member and each candidate member in the set of candidate members in the particular member's career trajectory. To determine the professional similarity between the set of candidate members and the particular member, the process 400 determines each candidate member's job titles, job descriptions, project descriptions, education descriptions, and compares each professional attribute to the particular user's job titles, job descriptions, project descriptions, and education descriptions. The more similar the descriptions are between the particular member and a candidate member, the higher the professional similarity between the two.

For example, education descriptions, such as coursework, the field of study, degree, major, activities, and societies are taken into consideration when determining the professional similarity. Similarly, job descriptions, such as job titles, project description, job function, industry, employment type, and qualification are considered when determining professional similarity.

In some embodiments, the process 400 may use a keyword extraction mechanism to determine the professional similarity, determining how many keyword(s) included in the descriptions the candidate members and the particular member share. In another embodiment, a Vector space model and a Cosine similarity metric can be used to capture the similarities between a candidate member and a particular member. For example, the process determines a word-to-vector value on the keywords, compares the word-to-vector values with a corresponding word-to-vector value, and calculates one or more similar metrics by comparing the vectors.

5.2.3. Professional Seniority

At block 413, professional seniority is determined for each identified candidate in a set of candidate members. The professional seniority represents a level of industry experience and the seniority level within an organization. The professional seniority can be determined based on a job title, education level, a number of years from the graduation year of the highest education institution attended, a number of work years in the industry, the number of connections in the same industry, length of the job descriptions, and/or the number of endorsements or certificates. The determining factors for the professional seniority are non-exclusive and can include other deciding factors. Members with higher seniority may receive a higher page rank score, resulting in a greater number of links pointing to them, because the members tend to find the senior members more important than junior members in profile pages and likely to click on the links associated with the senior members.

In some embodiments, an influence score for each candidate member of the set of candidate members is determined. The influence score is a metric that evaluates the influential power of an influencer member on other members, having potentials to affect other members' actions or behaviors. The influence score can be calculated based on the number of connections of the candidate member or the online activity history of the candidate member (e.g., number of postings, number of shares, number of comments, number of likes) and/or of other users relative to the candidate member (e.g., profile page views of the candidate's profile page, messages sent to the candidate member, connection invitations sent to the candidate member). In some embodiments, a member with a higher influence score may be determined to be ranked higher than a member with a lower influence score and an influence score may also be considered when ranking of the similar members. An entity with a high professional seniority value can be considered as an influencer.

5.2.4. Linear Combination

At block 414, a linear combination operation combines all the scores generated by blocks 411-413. The operation may involve inputting the scores for the different attributes or features into a rules-based model or a machine-learned model. Different attributes or weighs may be associated with different weights.

Based on the collected metrics, the top N candidate members with the highest combined metric values are selected and links corresponding to the selected candidate members are determined. Each link associated with a different candidate member of the selected candidate members is included in the source web page for the particular entity (John Smith) as shown in FIG. 2.

5.3. Optimization

At block 420, the top N links 240A-240C are presented to the users on a graphical user interface and their respective user feedback is collected. The collected feedback data is used to recalculate coefficients to weigh the importance of each attribute/feature in ranking candidate members. Based on the user feedback, more meaningful links that are similar to the source profile can be generated.

5.3.1. Behavior Feedback Data

At block 421, behavior feedback data is collected. Feedback data can be determined by the user interaction with the electronic content. Non-limiting example statistics of user interactions with respect to a link include click-through rate, bounce rate, average staying time (of a page to which the link points), average interactions, pair-wise bounce rate, and number of clicks. For each example interaction, the metric value is tracked to calculate weight value for each criterion.

In some embodiments, CTR refers to a ratio of a number of clicks to a number of impressions. As a specific example, a click-through rate is with respect to a particular link. As another example, a click-through rate is with respect to a unique linking page-link pair. A high CTR of a link indicates that a content item to which a link points is similar and relevant to the profile presented on the source web page that contains the link. Based on the CTR, the system can determine the links that interest users the most. The calculated CTR is stored in the behavior and feedback database 139.

In some embodiments, average staying time is considered when determining the feedback data. Average staying time can be calculated based on the time a user “stays” with the particular content item on the web page before changing the view (e.g., another page with the different content item). The longer the user stays with the particular content item, it is determined that the user has a high interest in the particular content item. If the user clicks on the link on the web page and stays with the new profile page for an amount of time that is longer than a threshold amount of time, then it is determined that the candidate content is relevant to the profile page. In one embodiment, average scrolling actions may be considered. Staying time for each link is calculated for a number of users and an average staying time is calculated. The calculated average staying time is stored in the behavior and feedback database 139.

In some embodiments, web traffic is considered when determining the feedback data. Web traffic can be determined by a number of page views (e.g., how many pages have been visited by the user from the source page). All the activity downstream from the users can be calculated to determine the web traffic. In another embodiment, a bounce rate or a pair-wise bounce rate are considered when determining the feedback data. The bounce rate represents a number of times users return to a source page (i.e., that links/linked to the particular content item) when the users selected the link to the particular content item. A pair-wise bounce rate is a number of times that users landed on the source page, then moved to the particular content item and then went back to the source page divided by a number of times that users landed on the source page and then moved to the particular content item. The web traffic, the bounce rate, and the pair-wise bounce rate are stored in the behavior and feedback database 139.

5.3.2. Labeled Data

At block 422, the feedback data is used to generate labeled training data that comprises multiple training instances. Each instance of feedback indicates whether a link was clicked when it was displayed to an end-user, an identity of a member to which the link links, and an identity of the member described on the source (or linking) page that contained the link. Each instance may also indicate whether a bounce occurred relative to the link. For many instances of feedback, most or all of the links are not clicked. If there are one hundred links on a source page that a (e.g., guest) user visits, then one hundred instances of feedback are generated.

Each instance of feedback is analyzed to generate a training instance that includes a label that corresponds to whether the link indicated in the feedback instance was clicked. Each feedback instance is analyzed to retrieve a pair of member identifiers and use the pair of member identifiers to retrieve member data of the pair of members, for example, from a profile database. The member data of the pair of members are compared with each other to compute multiple feature values, such as whether the pair of members worked at the same employer in the past, whether the pair of members worked at the same employer in the past at the same time, an amount of time of overlap at the employer, whether the pair of members attended the same school, whether the pair of members have the same major, whether the pair of members have the same seniority level, a seniority level of the linked-to member, etc. Member-specific attributes and commonalities described previously may be used as the features in creating each training instance.

Each feature of the training data may initially be associated with a user-specified or random weight. Using one or more machine learning techniques, the weights are modified based on the training data. Thus, the machine learning techniques improves and optimizes weights of each feature, allowing the resulting trained model to score each candidate member, which scores are used to select relevant links for a particular page of a particular member.

5.3.3. Regression Model

At block 423, the regression model is applied to feature values related to a pair of members. If there are one hundred candidate members for a particular member, then the regression model is invoked one hundred times. Regression analysis is a statistical method that allows examining the relationships between two or more variables of interest. There are many types of regression analysis. Regression is one class of machine learning techniques. Embodiments are not limited to any particular class of machine learning techniques.

A machine learning technique determines which of these professional attributes (e.g., variables) are more important than the other professional attributes when determining the weight value for the more important professional attributes. The more important professional attributes are likely to have a higher weight than the less important professional attributes. For example, the professional seniority may be assigned a higher weight than a common school attribute if it is determined that users likely to click the links for the senior members than the member with the same school.

One or more machine learning techniques are used to train a prediction model to predict the performance of providing relevant links to electronic content. Machine learning explores the study and construction of algorithms that can learn from and make predictions on data. Such algorithms operate by building the prediction model from an example training set of input observations in order to make data-driven predictions or decisions expressed as outputs.

One or more machine learning techniques are implemented to generate a prediction model. The prediction model can be generated for each criterion. The prediction model predicts the desired output (e.g., links that are relevant and will increase traffic and click-through rates). The discrepancy between the prediction model and the actual performance (e.g., users clicking the links that are presented in the graphical user interface) is determined based on the feedback data. In doing so, a label is assigned to each instance and the prediction model is trained to predict the pre-assigned labels of the data correctly.

Blocks 414-423 comprise a feedback loop that, as more data is gathered from actual users interacting (or not interacting) with links selected using a prediction model, an updated (and improved) prediction model is generated and used to select links for web pages. The same web page (corresponding to the same particular member) may be the subject of a link selection at different times. For example, at a first time, a first set of links linking to a first set of members is determined for a web page of a particular member using a first prediction model. Later, at a second time, a second set of links linking to a second set of members is determined for the web page of the particular member using a second prediction model that is different than the first prediction model (e.g., same features, but different weights), where the second set of members is different than the first set of members.

### 6. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

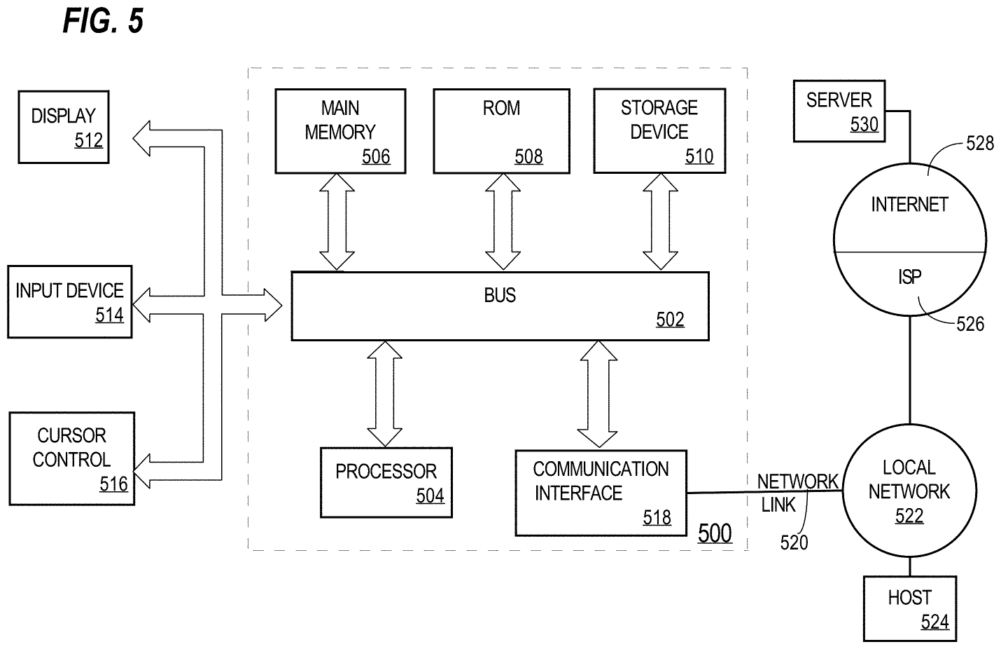

For example, FIG. 5 is a block diagram that illustrates a computer system 500 upon which an embodiment of the invention may be implemented. Computer system 500 includes a bus 502 or other communication mechanism for communicating information, and a hardware processor 504 coupled with bus 502 for processing information. Hardware processor 504 may be, for example, a general purpose microprocessor.

Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Such instructions, when stored in storage media accessible to processor 504, render computer system 500 into a special-purpose machine that is customized to perform the operations specified in the instructions.

Computer system 500 further includes a read only memory (ROM) 508 or other static storage device coupled to bus 502 for storing static information and instructions for processor 504. A storage device 510, such as a magnetic disk or optical disk, is provided and coupled to bus 502 for storing information and instructions.

Computer system 500 may be coupled via bus 502 to a display 512, such as a cathode ray tube (CRT), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

Computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor 504 executing one or more sequences of one or more instructions contained in main memory 506. Such instructions may be read into main memory 506 from another storage medium, such as storage device 510. Execution of the sequences of instructions contained in main memory 506 causes processor 504 to perform the process steps described herein. In alternative embodiments, hard-wired circuitry may be used in place of or in combination with software instructions.

The term “storage media” as used herein refers to any media that store data and/or instructions that cause a machine to operation in a specific fashion. Such storage media may comprise non-volatile media and/or volatile media. Non-volatile media includes, for example, optical or magnetic disks, such as storage device 510. Volatile media includes dynamic memory, such as main memory 506. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 502. Transmission media can also take the form of acoustic or light waves, such as those generated during radio-wave and infra-red data communications.

Various forms of media may be involved in carrying one or more sequences of one or more instructions to processor 504 for execution. For example, the instructions may initially be carried on a magnetic disk or solid state drive of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card, cable modem, satellite modem, or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the world wide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are example forms of transmission media.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518. The received code may be executed by processor 504 as it is received, and/or stored in storage device 510, or other non-volatile storage for later execution.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A method comprising:
identifying a plurality of entities that is associated with a particular entity;
wherein identifying the plurality of entities comprises:
identifying a set of entities that is associated with a particular organization with which the particular entity is associated;
ranking the set of entities based on one or more criteria; and
selecting the plurality of entities from the set of entities; and
based on selecting the plurality of entities, including, in a particular web page for the particular entity, a plurality of links, each of which links to a web page of a different entity of the plurality of entities;
wherein the method is performed by one or more computing devices.

2. The method of claim 1, wherein the one or more criteria comprises professional similarity, professional seniority, familiarity attributes, or common connection attributes.

3. The method of claim 1, wherein ranking the set of entities based on the one or more criteria comprises:
for each entity in the set of entities:
receiving values for the one or more criteria;
comparing the values associated with said each entity with respective values associated with the particular entity;
determining a similarity value based on the comparing;
ranking said each entity relative to other entities in the set of entities based on the similarity value.

4. The method of claim 1, wherein identifying the set of entities that is associated with a particular organization with which the particular entity is associated further comprises:
identifying one or more organizations associated with the set of entities;
wherein the one or more organizations share at least one characteristic with the particular organization;
for each entity in the set of entities:
calculating a period of employment at an organization of the one or more organizations;
determining whether the period of employment at the organization of the one or more organizations overlaps with a period of employment of the particular entity at the particular organization.

5. The method of claim 1, further comprising:
receiving feedback data indicating one or more user interactions associated with the plurality of links;
generating training data based on the feedback data, wherein each training instance in the training data comprise a plurality of feature values for a plurality of features; and
using one or more machine learning techniques to train a prediction model based on the training data, wherein the prediction model includes a set of weights for the plurality of features and is used to predict whether a user will select a particular link.

6. The method of claim 5, wherein selecting the plurality of entities is based on a plurality of scores generated by the prediction model for the plurality of entities.

7. The method of claim 5, wherein the plurality of features include a click-through rate of a candidate link or a number of web page views associated with a candidate entity.

8. One or more non-transitory computer-readable storage media storing instructions that, when executed by one or more processors, perform a method comprising:
identifying a plurality of entities that is associated with a particular entity;
wherein identifying the plurality of entities comprises:
identifying a set of entities that is associated with a particular organization with which the particular entity is associated;
ranking the set of entities based on one or more criteria; and
selecting the plurality of entities from the set of entities; and
based on selecting the plurality of entities, including, in a particular web page for the particular entity, a plurality of links, each of which links to a web page of a different entity of the plurality of entities;
wherein the method is performed by one or more computing devices.

9. The one or more non-transitory computer-readable storage media of claim 8, wherein the one or more criteria comprises professional similarity, professional seniority, familiarity attributes, or common connection attributes.

10. The one or more non-transitory computer-readable storage media of claim 8, wherein ranking the set of entities based on the one or more criteria comprises:
for each entity in the set of entities:
receiving values for the one or more criteria;
comparing the values associated with said each entity with respective values associated with the particular entity;
determining a similarity value based on the comparing;
ranking said each entity relative to other entities in the set of entities based on the similarity value.

11. The one or more non-transitory computer-readable storage media of claim 8, wherein identifying the set of entities that is associated with a particular organization with which the particular entity is associated further comprises:
identifying one or more organizations associated with the set of entities;
wherein the one or more organizations share at least one characteristic with the particular organization;
for each entity in the set of entities:
calculating a period of employment at an organization of the one or more organizations;
determining whether the period of employment at the organization of the one or more organizations overlaps with a period of employment of the particular entity at the particular organization.

12. The one or more non-transitory computer-readable storage media of claim 8, when executed, the method further comprising:
receiving feedback data indicating one or more user interactions associated with the plurality of links;
generating training data based on the feedback data, wherein each training instance in the training data comprise a plurality of feature values for a plurality of features; and
using one or more machine learning techniques to train a prediction model based on the training data, wherein the prediction model includes a set of weights for the plurality of features and is used to predict whether a user will select a particular link.

13. The one or more non-transitory computer-readable storage media of claim 12, wherein selecting the plurality of entities is based on a plurality of scores generated by the prediction model for the plurality of entities.

14. The one or more non-transitory computer-readable storage media of claim 12, wherein the plurality of features includes a click-through rate of a candidate link or a number of web page views associated with a candidate entity.

15. A system comprising:
a processor; and
a memory storing instructions that, when executed by the processor, cause the processor to perform a method comprising:
identifying a plurality of entities that is associated with a particular entity;
wherein identifying the plurality of entities comprises:
identifying a set of entities that is associated with a particular organization with which the particular entity is associated;
ranking the set of entities based on one or more criteria; and
selecting the plurality of entities from the set of entities; and
based on selecting the plurality of entities, including, in a particular web page for the particular entity, a plurality of links, each of which links to a web page of a different entity of the plurality of entities;
wherein the method is performed by one or more computing devices.

16. The system of claim 15, wherein the one or more criteria comprises professional similarity, professional seniority, familiarity attributes, or common connection attributes.

17. The system of claim 15, wherein ranking the set of entities based on the one or more criteria comprises:
for each entity in the set of entities:
receiving values for the one or more criteria;
comparing the values associated with said each entity with respective values associated with the particular entity;
determining a similarity value based on the comparing;
ranking said each entity relative to other entities in the set of entities based on the similarity value.

18. The system of claim 15, wherein identifying the set of entities that is associated with a particular organization with which the particular entity is associated further comprises:
identifying one or more organizations associated with the set of entities;
wherein the one or more organizations share at least one characteristic with the particular organization;
for each entity in the set of entities:
calculating a period of employment at an organization of the one or more organizations;
determining whether the period of employment at the organization of the one or more organizations overlaps with a period of employment of the particular entity at the particular organization.

19. The system of claim 15, when executed, the method further comprising:
receiving feedback data indicating one or more user interactions associated with the plurality of links;
generating training data based on the feedback data, wherein each training instance in the training data comprise a plurality of feature values for a plurality of features; and
using one or more machine learning techniques to train a prediction model based on the training data, wherein the prediction model includes a set of weights for the plurality of features and is used to predict whether a user will select a particular link.

20. The system of claim 19, wherein selecting the plurality of entities is based on a plurality of scores generated by the prediction model for the plurality of entities.
